(19) United States
(12) Patent Application Publication
(10) Pub. No.: US 2011/0276417 A1
(43) Pub. Date: Nov. 10, 2011

(54) SYSTEM FOR PERSONALIZED PAYMENTS VIA MOBILE AND INTERNET CONNECTED DEVICES

(76) Inventors: Andrew Campbell, Canterbury (GB); Brian Docherty, Sketty (GB); Nick McGarvey, Whiteway Hill (GB)

(21) Appl. No.: 13/100,344

(22) Filed: May 4, 2011

Related U.S. Application Data
(60) Provisional application No. 61/331,432, filed on May 5, 2010.
(60) Provisional application No. 61/331,432, filed on May 5, 2010.

(51) Int. Cl. G06Q 20/00; G06Q 30/00

(52) U.S. Cl. 705/16

(57) ABSTRACT

The present invention allows a merchant to accept payments from both a physical (card—Chip/PIN, Magstripe or Contactless) and virtual (internet or server based) payments accounts. The customer decides how they wish to pay. If physical card account then they present the relevant card or tag. If the customer wants to pay by virtual account then the merchant tells the customer what they owe, the customer then uses their mobile or computer to make an internet payment via a server-based wallet, virtual account or internet payment account (i.e. PayPal) identifying the merchant by their merchant identification number. The merchant receives secure confirmation of payment to the PayPod in the form of a text or numeric message.

### CROSS-REFERENCE TO RELATED APPLICATIONS

The present application claims priority from Provisional U.S. Patent Application Ser. No. 61/331,432, filed on May 5, 2010, and incorporated herein by reference.

The subject matter of the present application is also related to the following Provisional U.S. Patent Applications, all of which are incorporated herein by reference:

Ser. No. 61/325,289, filed on Apr. 17, 2010 (DAMALAK-0002P);

Ser. No. 61/325,291, filed on Apr. 17, 2010 (DAMALAK-0003P);

Ser. No. 61/325,300, filed on Apr. 17, 2010 (DAMALAK-0004P);

Ser. No. 61/325,327, filed on Apr. 18, 2010 (DAMALAK-0005P); and

Ser. No. 61/331,432, filed on May 5, 2010 (DAMALAK-0008P).

### FIELD OF THE INVENTION

The present invention relates to Point of Sale Credit Card and Payment Terminals. In particular, the present invention is directed toward improved security of accepting virtual payment accounts at Point of Sale Credit Card and Payment Terminals.

### BACKGROUND OF THE INVENTION

Payment card systems are in widespread use. FIG. 1 schematically illustrates a typical transaction, as carried out in Prior Art payment system 100. To initiate the transaction, a customer (not shown) visits a retail store (not shown) operated by a merchant, selects goods (not shown) that he/she wishes to purchase, carries the goods to the merchant's point of sale terminal 104, and presents his/her payment card 102 to the point of sale terminal 104. The point of sale terminal 104 reads the customer's payment card account number from the payment card 102, and then sends an authorization request to an acquirer financial institution (FI) 106 with which the merchant has a relationship. The authorization request includes the payment card account number and the amount of the transaction, among other information. The authorization request is routed via a payment card system 108 to the issuer financial institution 110 that issued the customer's payment card 102. Arrows 112, 114 and 116 trace the path of the authorization request from the POS terminal 104 to the issuer 110.

Assuming that all is in order, the issuer FI 110 transmits a favorable authorization response to the point of sale terminal 104 through the payment card system 108 and via the acquirer FI 106. The path of the authorization response from the issuer FI 110 to the POS terminal 104 is traced by arrows 118, 120, 122. The transaction at the point of sale terminal 104 is then completed and the customer leaves the store with the goods. A subsequent clearing transaction initiated by the merchant results in a transfer of the transaction amount from the customer's payment card account 124 to an account that belongs to the merchant. The customer's payment card account 124 may be, for example, a debit card account, a prepaid card account or a credit card account. In the former case, the clearing transaction results in the funds being debited directly from the account 124. In the latter case, the clearing transaction results in a charge being posted against the account 124, and the charge subsequently appears on the customer's monthly credit card statement.

The foregoing description of the typical transaction may be considered to be somewhat simplified in some respects. For example, a so-called merchant processing system (not shown) may be interposed between the POS terminal and the acquirer FI. As is familiar to those who are skilled in the art, a merchant processing system may be operated by or on behalf of the merchant to form part of the communications path between the acquirer FI and a considerable number of POS terminals operated by the merchant. It is also often the case that a third party transaction processing service may operate to handle payment card transactions on behalf of the acquirer and on behalf of a large number of other like financial institutions.

U.S. Pat. No. 7,575,177, incorporated herein by reference, discloses an electronic money settlement method using a mobile communication terminal. In that Patent, a mobile device includes an antenna and at least one control device coupled to the antenna. The at least one control device is selectively operable in a first mode and in a second mode. In the first mode, the at least one control device transmits a payment card account number via the antenna to a point of sale terminal. In the second mode, the at least one control device transmits a message to the point of sale terminal via the antenna to request that the point of sale terminal download transaction information to the mobile device.

FIG. 2 is a block diagram that illustrates a transaction process in accordance with aspects of U.S. Pat. No. 7,575,177. The various components shown in FIG. 2, and discussed below, may be a subset of a larger system, indicated generally by reference numeral 200, for facilitating payments to merchants via credit cards, debit cards and the like. In the example embodiment illustrated in FIG. 2, only components of system 200 that operate with respect to a single transaction are shown.

The system 200 includes a merchant device 202, which may for example be a POS terminal or a suitably programmed mobile telephone or PDA (personal digital assistant) with communication capabilities. The latter two possible embodiments of the merchant device may for example be particularly appropriate for merchants who operate without a fixed place of business. Examples of such merchants may be flea market sellers, artisans and crafters who sell their handiwork at craft fairs, itinerant merchants, merchants in third world marketplaces or indeed any mobile merchant with a flexible or mobile place of business.

If the merchant device is a POS terminal, the latter may operate for the most part in a conventional manner or may alternatively have functionality that actively contributes to the transaction flow illustrated in FIG. 2. The POS terminal may be operated in any type of business establishment or retail store, including a “Mom and Pop” operation all the way up to a big box store that is part of a mega retail chain. In some particularly helpful embodiments, the merchant device may be installed in a store such as a small antiques or collectibles shop or the like in which the low volume of transactions may weigh against the expense and paperwork requirements involved in entering into a merchant-acquirer relationship with a Financial Institution.

Among other capabilities, the merchant device 202 may display transaction information to be read by the customer (not shown) and manually inputted by the customer into his/her mobile device 204. For example, the merchant device may display the total amount due for the transaction, and a merchant identification number. Alternatively, the merchant ID may be permanently displayed on a sticker affixed to the merchant device 202. In some embodiments, the merchant identification number may be the account number that identifies the merchant's payment card account to which payment transactions are to be routed. In other embodiments the merchant identification number may require translation into such an account number.

If the merchant identification number is the merchant's payment card number, steps may be taken to prevent misuse of the account number. For example, the account corresponding to the account number may be enabled only to have funds transfers credited thereto, but not to receive charges via the payment card system, and with any transfers out of the account in question going into a companion account, with a different number, from which charges may be made. The merchant identification number may in some embodiments be the merchant's mobile telephone number or another mobile identifier; this may be particularly convenient where the merchant device 202 is a mobile telephone.

In other embodiments, the merchant device 202 may have capabilities for transmitting the transaction information to the customer device 204. The transmitting of the transaction information from the merchant device 202 to the customer device 204 may be via wireless communication such as NFC (near field communication) or alternatively may be via a mobile telephone network using text messaging or the like.

The customer's mobile device 204 may for example be a mobile telephone with capabilities for initiating payment transactions in a payment card system. Operation of a mobile telephone to initiate funds transfers via a payment card system is for example described in U.S. patent application Ser. No. 11/836,945, filed Aug. 10, 2007, entitled “Payment Card Based Remittance System with Designation of Recipient By Mobile Telephone Number”, which is incorporated herein by reference. As an alternative, the customer's mobile device 204 may be a PDA with communication capabilities. In some embodiments, the customer's mobile device may initiate a payment transaction by interacting with a website operated by a payment services provider or by the issuer of the customer's payment card account.

FIG. 2 also shows, as included in the system 200, an issuer financial institution 206 which issued the customer's payment card account 208, a payment system 210 for routing transactions from issuer to issuer (and also, e.g., from acquirers to issuers), and an issuer financial institution 212 which issued the merchant's payment card account 214. Blocks 206 and 212 should also be understood to represent, respectively, computer systems operated by or on behalf of the customer issuer FI and the merchant issuer FI.

Arrows 216, 218, and 220 trace the path of the payment transaction, requested from the customer's mobile device 204, as routed from the customer issuer 206, via the payment system 210 to the merchant issuer 212. Arrows 222, 224, and 226 trace the path of acknowledgement messages from the merchant issuer 212 via the payment system 210 and the customer issuer 206 to the customer's mobile device 204. Arrow 228 represents a confirmation message sent from the merchant issuer 212 to the merchant device 202 to confirm that the payment transaction to pay for the pending sale has or will be credited to the merchant account 214. Upon receiving the confirmation message 228 the merchant may allow the sale or other exchange of value to be completed.

Although only two issuing FIs, one mobile device and one merchant device are shown in FIG. 2, it should be understood that the system 200, in a practical embodiment, may include numerous issuing FIs all connected to the payment system 210, a large number of merchant devices 202 and a very large number of customer mobile devices. Furthermore, the system 210 preferably also operates in accordance with the purchase transaction model illustrated in FIG. 1, and thus may include a considerable number of acquirer FIs as well. Of course, many if not all acquirer FIs may also be issuer FIs.

U.S. Pat. No. 7,575,177 relates to a merchant sending the customer the transaction details and then the customer completing payment via a money transfer from a card payment account their own to a card payment account owned by the merchant. The system is designed to accept only physical cards, such as magnetic encoded credit cards, or so-called “smart” cards with embedded chips. Increasingly, however, many merchants are doing business over the Internet or the telephone, where the physical card of the purchaser may not be present. In such transactions, the customer may input or read the card number to the merchant, and provide ancillary information (billing address, CVVS number, expiry date, and the like). Such transactions may be referred to as “virtual” card transactions as opposed to physical card transaction.

Thus, it remains a requirement in the art to provide a system as described in U.S. Pat. No. 7,575,177 that allows a user to utilize both actual physical card transactions as well as virtual card transactions.

### SUMMARY OF THE INVENTION

The present invention comprises a card terminal called “PayPod” which includes a device for accepting and connecting to a Physical Form Factor (such as cards or tags) representing Payment Accounts able to be used in the System described in FIG. 1, but which also accepts virtual account transactions from mobile or internet connected devices. The present invention represents an improvement over the aforesaid U.S. Pat. No. 7,575,177.

Unlike the device described in U.S. Pat. No. 7,575,177, however, the present invention allows a merchant to accept payments from both a physical (card—Chip/PIN, Magstripe or Contactless) form factor and a virtual (mobile, internet or server based) payment accounts. The customer decides how they wish to pay. If physical card account then they present the relevant card or tag and the process followed is set out in a similar manner as shown in Prior Art FIG. 1.

### BRIEF DESCRIPTION OF THE DRAWINGS

FIG. 1 is a block diagram that illustrates a conventional payment system of the Prior Art.

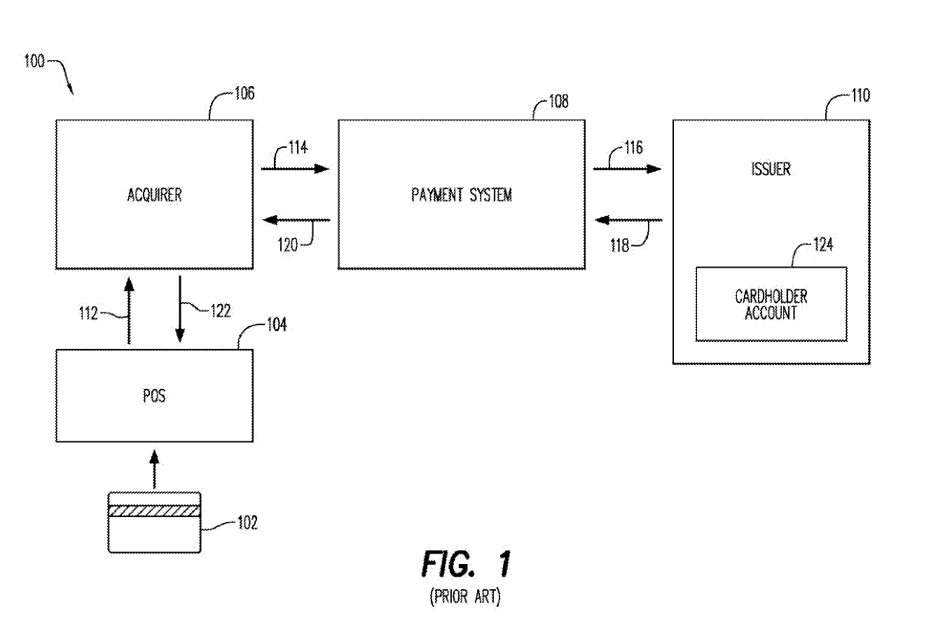

FIG. 2 is a block diagram that illustrates a transaction-handling system in accordance with another payment system of the Prior Art.

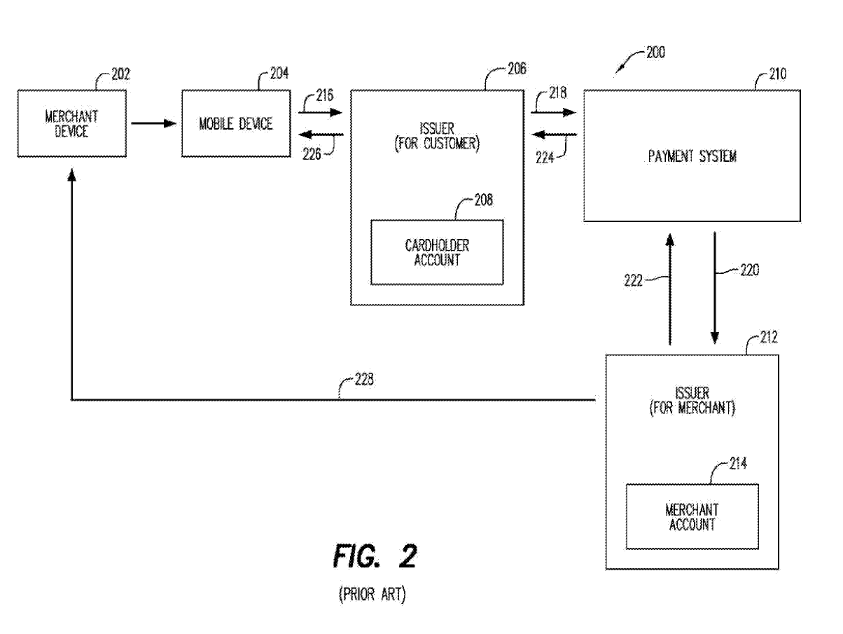

FIG. 3 is a block diagram of the apparatus and method of the present invention.

FIG. 4 is a frontal view of the PayPod card terminal of the present invention.

FIG. 5 is a block diagram illustrating the method steps used in the apparatus of FIG. 3.

### DETAILED DESCRIPTION OF THE INVENTION

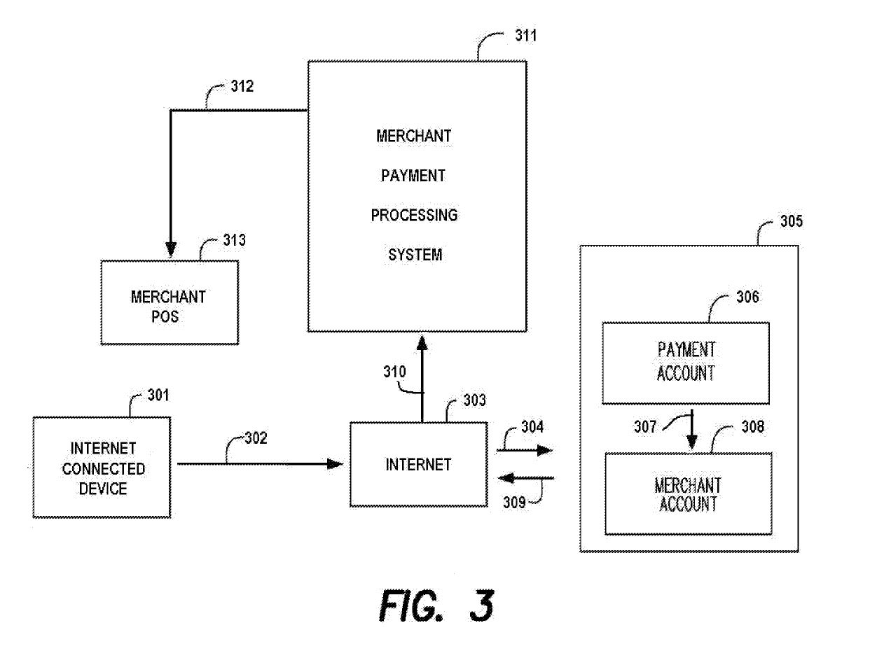

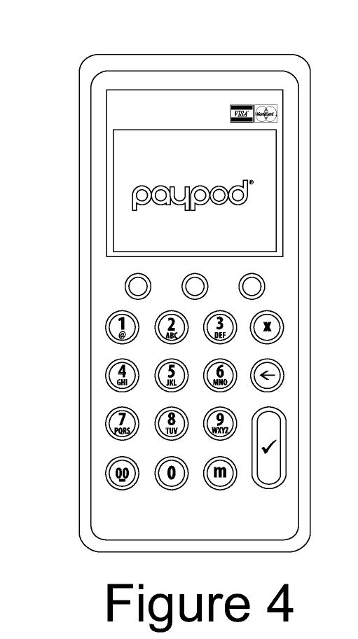

FIG. 4 is a frontal view of the PayPod card terminal of the present invention. The device includes a display, a keypad for inputting PIN numbers, payment amounts, and the like, and a card reader contact pad for accepting and connecting to a standard Smart Card. Referring to FIG. 3, if the customer wishes to pay by virtual (mobile, internet or server based) payment account then the merchant tells the customer (purchaser) what they owe and the customer then uses their mobile or internet connected device 301 to initiate a payment 302 using the merchant's identification number.

In some embodiments, the merchant identification number may be the account number that identifies the merchant's payment account to which payment transactions are to be routed. In other embodiments the merchant identification number may require translation into such an account number (i.e. a mobile telephone number or email address).

The mobile or Internet connected device connects to the Payment Service Provider or Account Issuer 305 via the Internet or mobile network 303. The Payment Service Provider or Account Issuer 305 hosts a server-based wallet, virtual account or Internet payment account (i.e. PayPal or Online Banking) on behalf or the Customer (Purchaser) 306 and the Merchant 308.

In some embodiments the Customer Account 306 and Merchant Account 308 may be with the same Payment Service Provider 305 or Account Issuer. In other embodiments the Customer Account 306 and the Merchant Account 308 may be with different Payment Service Providers 305 or Account Issuers. On receiving the payment request from the Customer 301, the Payment Service Provider 305 moves funds between the Customer Account 306 and the Merchant Account 308 as described by 307 on FIG. 3.

The Payment Service Provider 305 then confirms the payment has been made using the Merchant Identification Number 309 and 310. This notification is received by the Merchant Payment Processor 309, where it is securely routed 312 to the correct Merchant PayPod device 313. The merchant receives secure confirmation of payment to the PayPod in the form of a text or numeric message. The transaction at the PayPod terminal 313 may then be completed and the customer leaves with the goods.

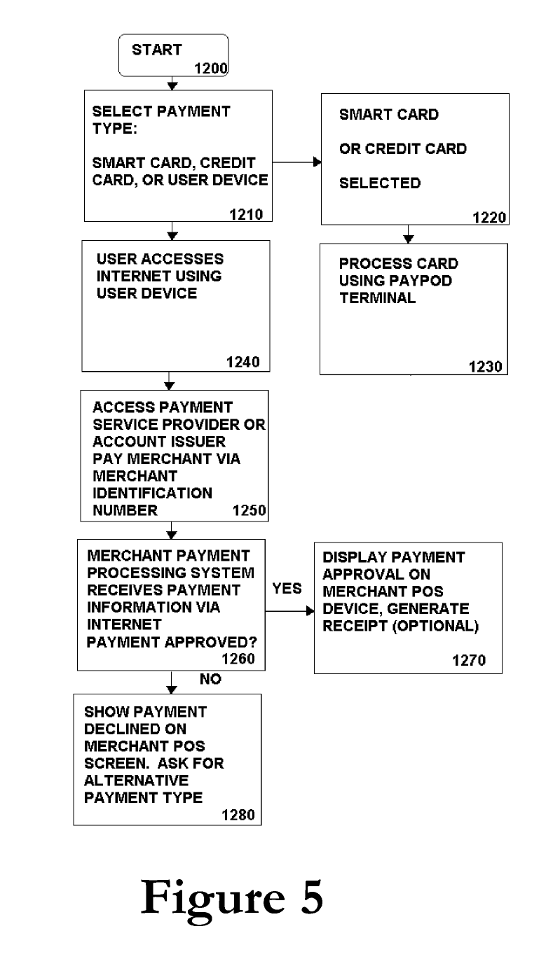

FIG. 5 is a block diagram illustrating the method steps used in the apparatus of FIG. 3. The process starts at step 1200. In step 1210, the customer (user) may select a payment type, which may be entered into the Merchant POS terminal such as that illustrated in FIG. 4. If the customer wishes to pay by traditional credit card or smart card, processing passes to step 1220 and the smart card or credit card is processed using the PayPod terminal of FIG. 4 in the traditional manner.

If, however, the customer wishes to pay by virtual (mobile, internet or server based) payment account then the merchant tells the customer (purchaser) what they owe and the customer then uses their mobile or internet connected device to initiate a payment over the Internet 1240. Such a mobile device may include, but not be limited to, a cellular telephone, smart phone, or other internet connected device, including an iPad, laptop, or other type of device with Internet access. In step 1250, the customer accesses the access payment service provider or account issuer using the merchant's identification number.

In some embodiments, the merchant identification number may be the account number that identifies the merchant's payment account to which payment transactions are to be routed. In other embodiments the merchant identification number may require translation into such an account number (i.e. a mobile telephone number or email address). This information may be given to the consumer verbally or as a message printed on a written bill or displayed on the PayPod terminal. This information may also be transmitted to the consumer's internet enabled device via the internet (e.g., by sending as a text message by entering the consumers telephone number or other identifying information into the PayPod device). The total amount due and the merchant identification data may then be displayed on the consumer's smart phone, for example, and an application (app) may be enabled to allow the consumer to consummate the transaction by hitting “accept”. The phone may then contact the merchant payment processing system as previously described to initiate and consummate the actual payment. Alternately, the merchant identification data and amount due data may be transmitted directly to the consumer's Internet enabled device (cell phone or the like) via bluetooth or other means. This data may then be used to access the merchant's payment account, e.g., through a cell phone application (app) or the like. The account payment service provider may be a bank, a merchant account company, an online payment company (e.g., PayPal or the like) or other entity that processes payments over the Internet on behalf of the merchant.

In step 1250, the mobile or Internet connected device connects to the Payment Service Provider or Account Issuer via the Internet or mobile network. The Payment Service Provider or Account Issuer hosts a server-based wallet, virtual account or Internet payment account (i.e. PayPal or Online Banking) on behalf or the Customer (Purchaser) and the Merchant. In some embodiments the Customer Account and Merchant Account may be with the same Payment Service Provider or Account Issuer. In other embodiments the Customer Account and the Merchant Account may be with different Payment Service Providers or Account Issuers. On receiving the payment request from the Customer in step 1250, the Payment Service Provider moves funds between the Customer Account and the Merchant Account in step 1260 as described by 307 on FIG. 3.

If the payment has been approved, the Payment Service Provider then confirms the payment has been made in step 1260 using the Merchant Identification Number. This notification is received by the Merchant Payment Processor, where it is securely routed to the correct Merchant PayPod device. The merchant receives secure confirmation of payment to the PayPod in the form of a text or numeric message in step 1270. The transaction at the PayPod terminal may then be completed and the customer leaves with the goods. A receipt may be generated physically or electronically at the merchant location. If the payment is not approved (insufficient funds, account information error, bad data, hacked account, stolen phone, or the like) the payment may be declined and that information displayed on the PayPod device as shown in step 1280.

While the preferred embodiment and various alternative embodiments of the invention have been disclosed and described in detail herein, it may be apparent to those skilled in the art that various changes in form and detail may be made therein without departing from the spirit and scope thereof.

We claim:

1. A method accepting payments from a consumer using a merchant portable payment terminal, the method comprising the steps of:
generating a bill for payment using the merchant portable payment terminal;
indicating, by the consumer, the payment method to be used;
if the payment method to be used is via customer internet device, indicating to the customer a merchant account identification;
accessing via internet, using a customer internet device, an account payment system;
uploading from the customer internet device, the merchant account identification and an amount to be paid;
authorizing, by the consumer, payment of the amount to be paid to the merchant, using the consumer internet device;
processing payment in the account payment system; and
outputting to the merchant portable payment terminal indication whether the payment has been processed.

2. The method of claim 1, where in the consumer Internet device comprises a smart phone, and the step of accessing via the Internet comprises sending a signal from the smart phone to the account payment system via a cellular communications link.

3. The method of claim 1, where the step of indicating by the consumer, the payment method to be used comprises the step of the consumer inputting a payment selection type into the merchant portable payment terminal.

4. The method of claim 1, wherein the step of indicating to the customer a merchant account identification comprises the step of displaying, on the merchant portable payment terminal merchant identification information.

5. The method of claim 1, wherein the step of indicating to the customer a merchant account identification comprises the step of electronically transferring to the consumer Internet device, the merchant identification information.

6. A system for accepting payments from a consumer using a merchant portable payment terminal, the system comprising:
a merchant portable payment terminal for generating a bill for payment using the merchant portable payment terminal and accepting input from the consumer, the payment system to be used, and if the payment system to be used is via customer internet device, indicating to the customer a merchant account identification;
an account payment system, accessible via Internet by at least one customer internet device, for receiving, from the consumer internet device, the merchant account identification and an amount to be paid and the account payment system for receiving authorization by the consumer through the consumer internet device, payment of the amount to be paid to the merchant, the account payment system processing the payment;
wherein the account payment system outputs to the merchant portable payment terminal indication whether the payment has been processed.

7. The system of claim 6, where in the consumer internet device comprises a smart phone for accessing via the internet by sending a signal from the smart phone to the account payment system via a cellular communications link.

8. The system of claim 6, wherein the consumer inputs a payment selection type into the merchant portable payment terminal.

9. The system of claim 6, wherein merchant portable terminal displays merchant identification information to the consumer for entry into the consumer Internet device.

10. The system of claim 6, wherein merchant portable terminal electronically transfers to the consumer Internet device, the merchant identification information.
